(19) United States
(12) Patent Application Publication
(10) Pub. No.: US 2019/0027262 A1
(43) Pub. Date: Jan. 24, 2019

(54) RADIATION-SHIELDING CLOTHING

(71) Applicants: VATECH Co., Ltd., Gyeonggi-do (KR); VATECH EWOO Holdings Co., Ltd., Gyeonggi-do (KR)

(72) Inventors: Min-seok YUN, Gyeonggi-do (KR); Yeong Kyun KIM, Gyeonggi-do (KR); Hyunsuk KIM, Gyeonggi-do (KR)

(73) Assignees: VATECH Co., Ltd., Gyeonggi-do (KR); VATECH EWOO Holdings Co., Ltd., Gyeonggi-do (KR)

(21) Appl. No.: 16/071,483

(22) PCT Filed: Jan. 19, 2017
(86) PCT No.: PCT/KR2017/000663

§ 371 Date: Jul. 19, 2018

(30) Foreign Application Priority Data
Jan. 19, 2016 (KR) 20-2016-0000293

(51) Int. Cl. G21F 3/02; A41D 13/05; A41D 31/00; A41D 27/20; G21F 1/08

(52) U.S. Cl. CPC G21F 3/02; A41D 13/05; A41D 2600/20; A41D 27/20; G21F 1/085; A41D 31/00

(57) ABSTRACT

The present invention relates to radiation-shielding clothing for limiting the radiation exposure of radiographers and assistants at the time of radiography by using a lightweight lead-free sheet shielding X-rays, the radiation-shielding clothing including: a top main body including a torso portion; and a shielding sheet, at least a part thereof being capable of being coupled to or detached from the top main body using attachment and detachment means, wherein the shielding sheet contains a substrate of a resin material and tungsten or tungsten oxide powder.

### TECHNICAL FIELD

The present invention relates to radiation-shielding clothing and, more particularly, to radiation-shielding clothing that limits the exposure of radiographers and assistants to radiation at the time of radiography using a lightweight lead-free sheet that shields X-rays.

### BACKGROUND ART

Recently, with the rapid development of diagnostic radiology, radiography using X-rays has become common. At the time of such radiography, a radiologist, a radiology assistant, and a patient are exposed directly or indirectly to X-rays. Therefore, the radiologist or other person proceeds with the photography after putting on an apron or a bathrobe containing lead, which is an X-ray-shielding material, in order to minimize radiation exposure.

However, since the above-described conventional shielding clothing using lead is heavy, efficiency becomes low in performing the photography and accompanying tasks for the radiologist or the other person wearing the heavy shielding clothing. Accordingly, the radiologist or other person is reluctant to put on the heavy shielding clothing in many cases, thereby causing a problem in that the radiologist or other person may be exposed to radiation.

In addition, since lead, which is used as the shielding material, is very harmful to the human body as well as to the environment, components harmful to the human body may be generated due to the shielding clothing worn by the radiologist or other person to prevent radiation exposure.

[Related Art Documents] Korean Utility Model Registration No. 20-0397040

### DISCLOSURE

### Technical Problem

Accordingly, the present invention has been made keeping in mind the above problems occurring in the related art, and an object of the present invention is to provide radiation-shielding clothing which is free from concerns pertaining to lead and can be worn without the burden of the weight thereof by allowing a shielding sheet to be attached to and detached from an area sensitive to radiation exposure, wherein the shielding sheet is made of a material that is lightweight and harmless to a human body.

### Technical Solution

An embodiment to accomplish the above object includes a top main body including a torso portion; and a shielding sheet, at least a part thereof being coupled to or detached from the top main body using attachment and detachment means, wherein the shielding sheet contains a substrate of a resin material and tungsten or tungsten oxide powder.

Here, the attachment and detachment means is a pocket which is provided inside of a front surface of the top main body, and in which the shielding sheet is mounted.

In addition, the attachment and detachment means is at least one of Velcro, a button, and a zipper.

Meanwhile, the top main body includes a collar of a regular-type collar, formed in a neck area of the top main body, and provided with left and right distal ends, wherein the collar includes: a fastening area provided on a rear surface of one of the left and right distal ends, and allowing the collar to surround rear and front areas of a collum with one of the left and right distal ends being inserted the other one when the collar is in an upright position; and a pocket which is formed on one of the left and right distal ends, and in which the shielding sheet is mounted.

Meanwhile, the shielding sheet has a thickness of 0.15 to 2 mm and shields 70% or more of radiation of tube voltage of 50 to 90 kVp.

In addition, the shielding sheet has a density of 0.75 to 1.25 g/cm².

Meanwhile, a grain diameter of the tungsten or tungsten oxide powder is 500 nm or less on average.

In addition, the resin material is one of a polyolefin resin, polypropylene, vinyl chloride or polyvinyl chloride resin, a silicone polymer, and a polyester resin; and 100 to 300 parts by weight of the tungsten or tungsten powder is distributed in 100 parts by weight of the resin material.

### Advantageous Effects

The present invention constructed as described above has an effect of providing, without any harm to the human body, a function that protects a wearer of the shielding clothing from radiation exposure, by providing shielding clothing capable of attaching a shielding sheet manufactured using tungsten or tungsten oxide, which is a harmless substance to the human body.

In addition, the present invention has an advantage of preventing a decrease in working efficiency due to the weight of the shielding clothing and of wearing the shielding clothing conveniently since the shielding sheet is detachably attached to the main body of the shielding clothing, wherein the shielding sheet is manufactured using lightweight tungsten or tungsten oxide, and the manufactured shielding sheet is attached to shield an area of the human body that is sensitive to radiation exposure.

### DESCRIPTION OF DRAWINGS

FIG. 1 is a view showing the appearance of radiation-shielding clothing according to an embodiment of the present invention.

FIGS. 2a and 2b are views showing examples of first attachment and detachment means and second attachment and detachment means, respectively, provided in the radiation-shielding clothing of the present invention.

FIGS. 3a and 3b are views showing an example of a shielding sheet for protecting a thyroid area in the radiation-shielding clothing of the present invention.

FIGS. 4a to 4c are views showing another example of a shielding sheet for protecting the thyroid area in the radiation-shielding clothing of the present invention.

FIGS. 5a and 5b are views showing the appearance of radiation-shielding clothing according to another embodiment of the present invention.

### DESCRIPTION OF THE REFERENCE NUMERALS IN THE DRAWINGS

100: Top main body

200: Shielding sheet

### MODE FOR INVENTION

Embodiments of the present invention will be described in detail with reference to accompanying drawings.

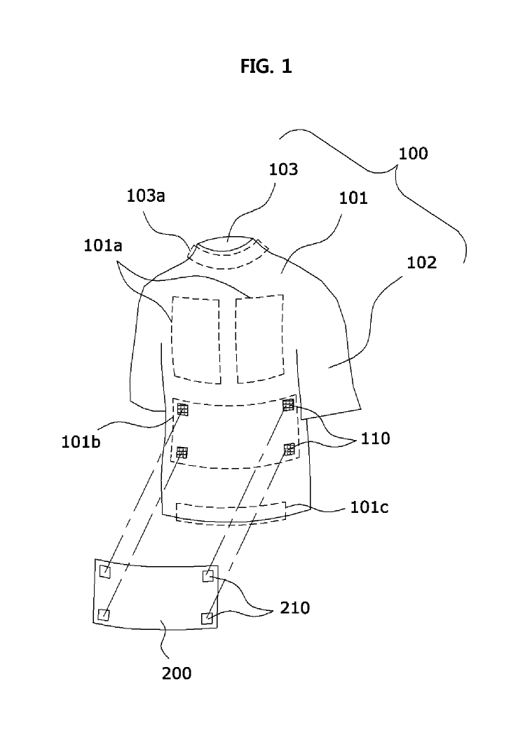

FIG. 1 is a view showing the appearance of radiation-shielding clothing according to an embodiment of the present invention, wherein the radiation-shielding clothing of the present invention includes a top main body 100 and a shielding sheet 200.

The top main body 100 may include a torso portion 101, a sleeve 102, and a collar 103 in the form of a medical doctor's gown or nurse's uniform. Here, the top main body 100 includes a first attachment and detachment means 110 provided on the front surface of the torso portion 101 and capable of being coupled to or disassembled from a second attachment and detachment means 210 provided on the shielding sheet 200.

In addition, the shielding sheet 200 is a sheet manufactured by processing a resin composition mixed with tungsten or tungsten oxide powder and includes a second attachment and detachment means 210 installed to be coupled to or detached from the first detachment means 110, thereby being coupled to and detached from the top main body 100 by coupling or disassembling the first attachment and detachment means 110 and the second attachment and detachment means 210.

Here, the shielding sheet 200 is provided on an area sensitive to radiation, such as a neck area (a collum, in particular, a thyroid area) 103a, a chest area 101a, an abdominal area 101b, a genital area 101c or the like, thereby enabling the above areas to be prevented from radiation exposure. Meanwhile, it is preferable that the length of the top main body 100 be longer than that of a general medical doctor's gown or nurse's uniform so that the shielding sheet 200 is capable of being attached so as to cover the genital area 101c.

In addition, the first attachment and detachment means 110 and the second attachment and detachment means 210, provided on the abdominal area 101b as an example in FIG. 1, are allowed to be provided on any area sensitive to radiation, such as the neck area 103a, the chest area 101a, the genital area 101c and the like.

Meanwhile, the shape of the shielding sheet 200 may be polygonal or U-shaped, as well as rectangular, as shown in FIG. 1, for the neck 103a, polygonal for the chest area 101a and the abdominal area 101b, and triangular for the genital area 101c.

For reference, the shielding sheet 200 includes a substrate made of a resin material and tungsten or tungsten oxide powder dispersed therein and may shield 70% or more of radiation of tube voltage of 50 to 90 kVp, wherein the shielding sheet 200 may have a thickness of 0.15 to 2 mm and a density of 0.75 to 1.25 g/cm².

The resin material may be one of polyolefin resin, polypropylene, vinyl chloride or polyvinyl chloride resin, silicone polymer, and polyester resin. In addition, the tungsten or tungsten oxide powder may have a grain diameter of 500 nm or less, preferably 50 to 100 nm, and the amount of dispersion increases at the same weight when the size of the tungsten or tungsten oxide powder is reduced, thereby causing an effect in which the radiation-shielding effect is enhanced.

When the weight of the resin material is 100 parts by weight, tungsten or tungsten oxide powder may be added in an amount of 100 to 300 parts by weight, preferably 150 to 250 parts by weight. At this time, the content of tungsten or tungsten oxide is controlled in consideration of the thickness of the radiation-shielding sheet in the final product. That is, the content of tungsten or tungsten oxide should become greater as the thickness of the shielding sheet becomes thinner in order to obtain the same shielding performance.

For example, the amount of the tungsten powder dispersed in the shielding sheet 200 can be dispersed in a range of 0.5 to 1.1 g, preferably 0.7 to 1.05 g, per cm² of the radiation-shielding sheet. Under such conditions, the radiation-shielding sheet exhibits adequate elasticity and rigidity, while shielding 70% or more of radiation of tube voltage of 50 to 90 kVp.

Meanwhile, the shielding sheet 200 may further contain at least one of a modifier, a plasticizer, an antioxidant, a heat stabilizer, a flame retardant, and a lubricant as an additive.

The modifier used as an additive is material that improves the machinability of substrate by changing the characteristics of the resin constituting the substrate and enables the substrate to adhere easily to a cloth or a film. The modifier may be polymethyl methacrylate (PMMA) or polytetrafluoroethylene (PTFE), and is added in the range of 1 to 50 parts by weight based on 100 parts by weight of the resin constituting the substrate. PMMA or PTFE may be added alone, but alternatively, a product blended in advance appropriately for the processing of the resin may be used. The modifier may improve the shielding performance by improving the dispersibility of the tungsten powder, but is not a component that directly affects the shielding performance. Consequently, the conventional technique can be applied without any limitation to the extent that the characteristics of the present invention are not impaired. Accordingly, a detailed description of the modifier is omitted.

The plasticizer used as an additive can also have an effect of improving the dispersibility of the tungsten powder as a substance that improves the flexibility of the resin constituting the substrate.

The plasticizer can be at least one selected from those of phthalic acid esters, aliphatic dibasic acid esters, phosphoric acid esters, trimellitic acid esters, glycol esters, epoxidized esters, citric acid esters, tetra-n-octyl citrate, polypropylene adipate and polyester. Phthalic acid ester plasticizers include dimethyl phthalate, diethyl phthalate, dibutyl phthalate, phthalic acid-n-octyl, di-isodecyl phthalate, diisononyl phthalate, butyl benzyl phthalate, and phthalic ester. Aliphatic dibasic acid esters plasticizers include dibutyl adipate, di-n-hexyl adipate, dibutyl sebacate, and the like. Phosphoric ester plasticizers include tributyl phosphate, tri-2-n-ethylhexyl phosphate, tricresyl phosphate, and triphenyl phosphate. Trimellitic acid ester plasticizers include tri-2-ethylhexyl trimellitate and tributyl trimellitate. Glycol ester plasticizers include pentaerythritol ester and diethylene glycol benzoate. The epoxidized ester plasticizers include epoxidized soybean oil and epoxidized linseed oil. Citric acid ester plasticizers include acetyl tributyl citrate, acetyl tri-octyl citrate and tri-n-butyl citrate. The plasticizer is added in the range of 20 to 200 parts by weight based on 100 parts by weight of the polymer resin constituting the substrate.

The antioxidant used as an additive is a substance added to prevent the formation of radicals in the course of processing the resin. Radicals induce a cross-linking reaction or chain-cleavage reaction of the resin, thereby causing the resin to lose its original physical properties and accordingly shortening the lifetime of the resin.

The antioxidants are generally classified into a primary antioxidant to remove radicals generated during initiation and chain reaction and a secondary antioxidant to prevent the diffusion of RO and ROO by ROOH decomposition. The primary antioxidants include phenolic-based antioxidants and amine-based antioxidants, and the secondary antioxidants include sulfur-based antioxidants and phosphorus-based antioxidants. The secondary antioxidant also has the effect of preventing the yellowing of the polymer resin, and it is common to use a primary antioxidant and a secondary antioxidant together. The antioxidant is not a component that directly affects the shielding performance. Consequently, the conventional technology can be applied without any limitation to the extent that the characteristics of the present invention are not impaired. Accordingly, a detailed description of the antioxidant is omitted.

In addition, the shielding sheet 200 may use heat stabilizers, flame retardants and lubricants as additives.

The heat stabilizer facilitates a manufacturing process at high temperatures by slowing the ignition of the resin, having a characteristic of burning easily, and by preventing the expansion of the burning. Ba-Zn-based heat stabilizers and the like are available, wherein the heat stabilizers may be used alone or in a combination of two or more, or commercially available products may also be used.

The flame retardant is added to prevent the resin from burning, and may be used alone or in a combination of two or more of those such as a melamine cyanurate compound, hydrotalcite, tartaric acid zinc, zinc hydroxytartrate, zinc borate, zinc oxide, tin oxide, titanium oxide, magnesium oxide, molybdenum oxide, molybdenum sulfide, carbon, clay, silica, alumina, calcium carbonate, magnesium carbonate, talc, zeolite, antimony trioxide, silicone compound, glass fiber and the like.

The lubricant may be an aliphatic hydrocarbon-based lubricant such as low-molecular-weight wax, polyethylene wax, paraffin wax and liquid paraffin; a higher aliphatic alcohol-based lubricant such as stearyl alcohol; aliphatic amide-based lubricants such as stearic acid amide, palmitic acid amide, and methylene vis tear; a fatty acid ester-based lubricant such as glyceryl stearate, ethyl diamino stearate, and butyl stearate; a metal soap, or an acryl-based polymer, which may be used alone or in a combination of two or more.

Because the heat stabilizer, the flame retardant, and the lubricant are not components that directly affect the shielding performance, the conventional technology can be applied without any limitation to the extent that the characteristics of the present invention are not impaired. In this context, a detailed description thereof is omitted.

In addition, the shielding sheet 200 can be obtained through press molding, wherein a substrate of a resin material is mixed with tungsten or tungsten oxide powder, and the mixed raw material is manufactured into a sheet form.

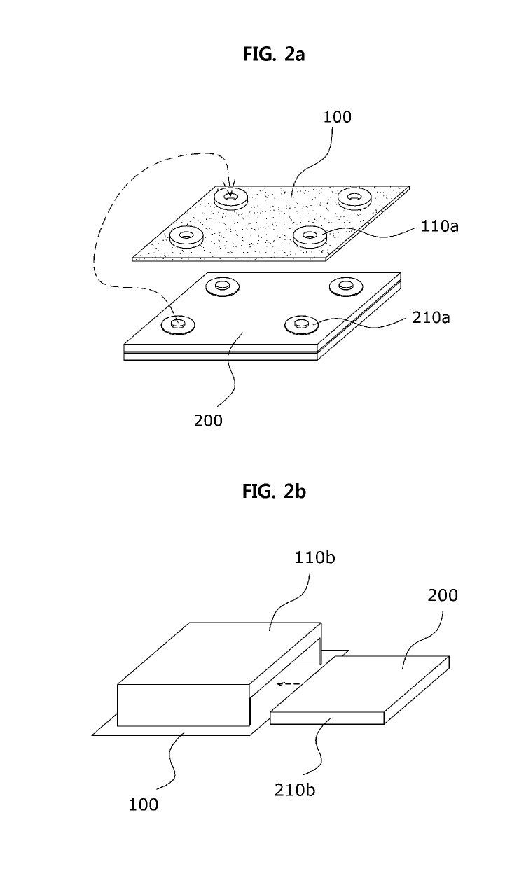

Meanwhile, FIGS. 2a and 2b are views illustrating an example of a first attachment and detachment means 110 and a second attachment and detachment means 210 provided in the radiation-shielding clothing of the present invention. As illustrated in FIG. 2a, the first attachment and detachment means 110 may be a first snap fastener 110a, and the second attachment and detachment means 220 may be a second snap fastener 210a for engaging with the first snap fastener 110a.

In addition, as illustrated in FIG. 2b, a first attachment and detachment means 110 is a pocket 110b and a second attachment and detachment means 210 is formed by the edges 210b of the shielding sheet 200, which is cut smaller than the size of the pocket 110b. At this time, the first attachment and detachment means 110 is preferably a front pocket provided on the inner side of the front surface of the top main body in a form such that the shielding sheet 200 is mounted thereto, thereby shielding the chest part of a user from radiation, but is not limited thereto.

Here, the pocket 110b may be used for storing a Thermo-Luminescence Dosimeter (TLD) badge therein and also managing the cumulative radiation dose therethrough. In addition, it is also possible for the pocket to implement a function of warning the user wearing the radiation-shielding clothing of the present invention according to the cumulative radiation dose measured by the TLD badge.

Besides, even though not shown, the first attachment and detachment means 110 and the second attachment and detachment means 210 can be attached to or detached from the top main body 100 using any possible means, such as a Velcro type, a ring type, or the like. Here, when the first attachment and detachment means 110 and the second attachment and detachment means 210 are Velcro, the second attachment and detachment means 210 may be formed on opposite sides of the shielding sheet 200 for convenience.

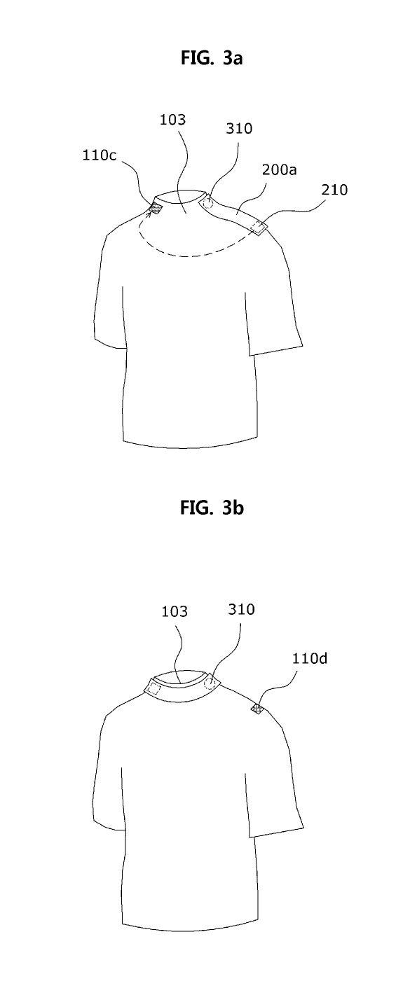

FIGS. 3a and 3b are views illustrating an example of a shielding sheet 200 for protecting a thyroid area in the radiation-shielding clothing of the present invention. The basic shape of the shielding sheet 200 is the state shown in FIG. 3a, in which the second attachment and detachment means 210 of the strap-type shielding sheet 200a covering the shoulder of the same side in one side of a collar is attached to the first attachment and detachment means 110d provided on the same side of the shoulder. On the other hand, the shape used at the time of radiography is the state shown in FIG. 3b, in which the second attachment and detachment means 210 of the strap-type shielding sheet 200a is detached from the first attachment and detachment means 110d provided on one shoulder, and is attached to the first attachment and detachment means 110c provided on a side in another side of the collar 103.

Here, the strap-type shielding sheet 200a may be connected to the one side of the collar 103 through the binding means 310, wherein it is desirable to provide the binding means 310 with a rotatable binding system that can move the strap-type shielding sheet 200a to a position where the shielding sheet 200a can cover the thyroid area. For example, the binding means 310 may be a button, a snap fastener, Velcro, a ring, or the like.

In addition, unlike what is illustrated in FIGS. 3a and 3b, a method may be adopted such that the entire strap-type shielding sheet 200a is detached from the shoulder and is attached subsequently to the collar 103 in a manner of wrapping the thyroid area without providing the binding means 310 between the strap-type shielding sheet 200a and the collar 103.

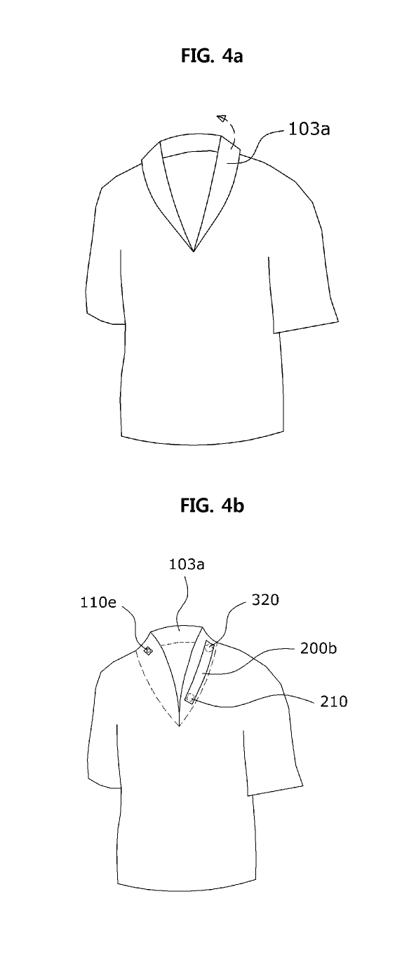

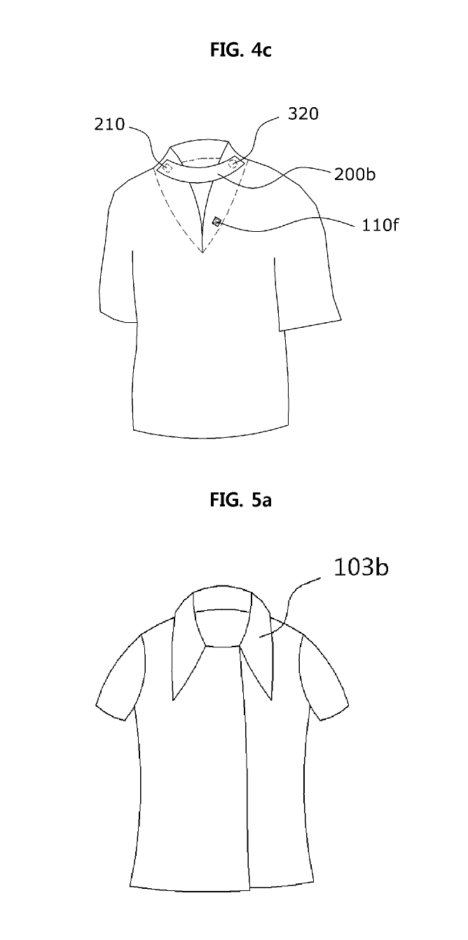

FIGS. 4a to 4c are views illustrating another example of the shielding sheet 200 for protecting the thyroid area in the radiation-shielding clothing of the present invention. The basic shape of the shielding sheet 200 is the type shown in FIG. 4a, in which a hidden-type shielding sheet 200b is made invisible from the outside by attaching the second attachment and detachment means 210 of the hidden-type shielding sheet 200b to the first attachment and detachment means 110f provided on the inner side of a first regular-type collar 103a.

Meanwhile, to form the shape used at the time of radiography, the first regular-type collar 103a is forced to be in an upright position first, thereby exposing the hidden-type shielding sheet 200b and the first attachment and detachment means 110e which is provided on a position suitable for the hidden-type shielding sheet 200b to cover the thyroid area.

Thereafter, the shape used at the time of radiography is completed as shown in FIG. 4c by attaching the second attachment and detachment means 210 of the hidden-type shielding sheet 200b to the first attachment and detachment means 110e, provided on the inner side of the first regular-type collar 103a, after detaching the second attachment and detachment means 210 of the hidden-type shielding sheet 200b from the first attachment and detachment means 110f, provided on the inner side of the first regular-type collar 103a, whereby the hidden-type shielding sheet 200b can suitably cover the thyroid area.

Here, the hidden-type shielding sheet 200b may be connected to the other side of the first regular-type collar 103a, other than the side on which the first attachment and detachment means 110e is provided, through the binding means 320, wherein it is desirable to provide the binding means 320 with a rotatable binding system that can move the hidden-type shielding sheet 200b to a position where the hidden-type shielding sheet 200b can cover the thyroid area. For example, the binding means 310 may be a button, a snap fastener, Velcro, or a ring.

In addition, unlike those illustrated in FIGS. 4a to 4b, a method may be adopted such that the entire hidden-type shielding sheet 200b is detached and attached subsequently to the first regular-type collar 103a in a manner that covers the thyroid area without providing the binding means 320 between the hidden-type shielding sheet 200b and the first regular-type collar 103a.

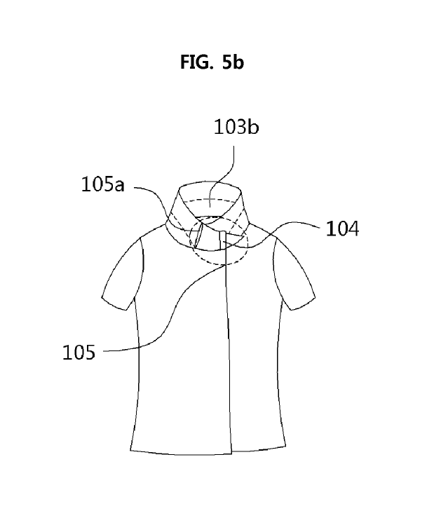

FIGS. 5a and 5b are drawings illustrating the appearance of radiation-shielding clothing according to another embodiment of the present invention. The radiation-shielding clothing according to another embodiment of the present invention is provided with a second regular-type collar 103b, wherein the second regular-type collar 103b has left and right distal ends that are elongated.

That is, the second regular-type collar 103b is formed in the neck area of the top main body and is formed to surround the rear and front areas of a collum when the collar is in an upright position, as shown in FIG. 5b, wherein the left and right distal ends thereof have an elongated shape.

At this time, on the rear surface of one of the left and right distal ends of the second regular-type collar 103b, a ring-shaped fastener 104 can be formed to fasten the other distal end when the collar is in an upright position.

In addition, a collum pocket 105 in which the shielding sheet 200 is mounted is formed on the rear surface of one of the left and right distal ends of the second regular-type collar 103b, wherein the collum pocket 105 can cover and hide the front of the collum, particularly the thyroid area, and an entrance 105a of the collum pocket 105 may be provided on the corresponding rear side of the second regular-type collar 103b, as in FIG. 5b. At this time, the shielding sheet 200 may be formed in a triangular shape to be mounted on the collum pocket 105 formed at the end of the second regular-type collar 103b, but without limitation thereto.

While the present invention has been described through exemplary embodiments thereof, the above-described embodiments are merely illustrative of the technical ideas of the present invention, and those skilled in the art will understand that various changes in form and details may be made therein without departing from the spirit and scope of the invention as defined by the appended claims. Therefore, the scope of protection of the present invention should be construed not only in the specific embodiments but also in the scope of the claims, and all technical ideas within the scope of equivalents should be interpreted as being included in the scope of the present invention.

1. Radiation-shielding clothing, comprising:
a top main body including a torso portion; and
a shielding sheet, at least a part thereof being coupled to or detached from the top main body using attachment and detachment means,
wherein the resin material is one of a polyolefin resin, polypropylene, vinyl chloride or polyvinyl chloride resin, a silicone polymer, and a polyester resin; and 100 to 300 parts by weight of the tungsten or tungsten powder is distributed in 100 parts by weight of the resin material
wherein the shielding sheet contains a substrate of a resin material and tungsten or tungsten oxide powder, has a density of 0.75 to 1.25 g/cm², and has a thickness of 0.15 to 2 mm and shields 70% or more of radiation of tube voltage of 50 to 90 kVp.

2. The radiation-shielding clothing of claim 1, wherein the attachment and detachment means is a pocket which is provided inside of a front surface of the top main body, and in which the shielding sheet is mounted.

3. The radiation-shielding clothing of claim 1, wherein the attachment and detachment means is at least one of Velcro, a button, and a zipper.

4. The radiation-shielding clothing of claim 1, wherein the top main body includes a collar of a regular-type collar, formed in a neck area of the top main body, and provided with left and right distal ends,
wherein the collar includes:
a fastening portion provided on a rear surface of one of the left and right distal ends, and allowing the collar to surround rear and front areas of a collum with one of the left and right distal ends being inserted thereinto the other one when the collar is in an upright position; and
a pocket formed on one of the left and right distal ends, and in which the shielding sheet is mounted.

5. (canceled)

6. (canceled)

7. The radiation-shielding clothing of claim 1, wherein a grain diameter of the tungsten or tungsten oxide powder is 500 nm or less on average.

8. (canceled)
